(19) United States
(12) Patent Application Publication
(10) Pub. No.: US 2025/0244945 A1
(43) Pub. Date: Jul. 31, 2025

(54) SYSTEMS AND METHODS FOR SYNCHRONIZING A PLURALITY OF ISOCHRONOUS STREAMS

(71) Applicant: Bose Corporation, Framingham, MA (US)

(72) Inventors: Rasmus Abildgren, Skørping (DK); Casper Stork Bonde, Støvring (DK); Don L. Drinkwater, Carlisle, MA (US)

(73) Assignee: Bose Corporation, Framingham, MA (US)

(21) Appl. No.: 18/422,269

(22) Filed: Jan. 25, 2024

(51) Int. Cl. G06F 3/16; H04R 5/04

(52) U.S. Cl. CPC G06F 3/165; H04R 5/04; H04R 2420/07

(57) ABSTRACT

The present disclosure provides systems and methods for synchronizing isochronous streams. The system includes a plurality of audio sources and a conducting device. Each of the plurality of audio sources is configured to stream packets of audio data to the other audio sources via one or more isochronous streams. The audio data may correspond to audio captured by an audio sensor of the audio source, such as a microphone, or to audio provided to the audio source via an external source, such as a smartphone or a remote server. The conducting device is configured to provide group timing information to the plurality of audio sources. Each of the plurality of audio sources transmit packets of audio data in a time-aligned manner according to the group timing information to avoid interference. The conducting device may also provide audio data to the audio sources in addition to the group timing information.

### FIELD OF THE DISCLOSURE

The present disclosure is generally directed to systems and methods for synchronizing a plurality of isochronous streams.

### BACKGROUND

In a Bluetooth LE Audio broadcast isochronous stream, a single transmitting device transmits data to be received by one or more receiving devices. Examples of implementing a broadcast isochronous stream may include several passengers in a vehicle simultaneously streaming audio from an in-vehicle infotainment system, several patrons in a sports bar simultaneously streaming audio from a television, or several employees in a workplace streaming audio from a central system. However, in those examples, the passengers, the bar patrons, or the employees may also wish to communicate with each other via their individual Bluetooth-enabled devices in a manner similar to a traditional intercom, while also maintaining the audio stream from the infotainment system, television, central system, or other analogous device or system.

### SUMMARY OF THE DISCLOSURE

The present disclosure provides systems and methods for synchronizing isochronous streams. The system includes a plurality of audio sources and a conducting device. Each of the plurality of audio sources is a device configured to directly or indirectly stream packets of audio data to the other audio sources via one or more isochronous streams. An isochronous stream is a stream of data in which events occur regularly or at equal time intervals. The audio data may correspond to audio captured by an audio sensor of the audio source, such as a microphone, or to audio provided to the audio source via an external source, such as a smartphone or a remote server. The conducting device is configured to provide group timing information to the plurality of audio sources. In some examples, the conducting device may also serve as an additional audio source. Each of the plurality of audio sources transmit packets of audio data in a time-aligned manner according to the group timing information to avoid interference. Accordingly, the plurality of isochronous streams are synchronized to form an isochronous group of isochronous streams, enabling each audio source to receive data packets from each stream.

Further, each packet may include a header with destination data indicating the desired recipient audio source of the packet. If the packet is received by the desired recipient audio source, that audio source may then render audio corresponding to the received packet. Otherwise, the receiving audio source may ignore the packet or disable reception of the packet. Accordingly, the destination data may enable a sub-group of audio sources to communicate with each other as a closed group via the one or more isochronous streams.

In one example, each audio source is configured to directly transmit audio data to the other audio sources via a plurality of broadcast isochronous streams (“BISs”). The plurality of broadcast isochronous streams may be considered a virtual broadcast isochronous group (“VBIG”). In this example, the conducting device provides each of the audio sources with a periodic advertisement with the group timing information. Further, the conducting device may also transmit a broadcast isochronous stream to the plurality of audio sources via an additional broadcast isochronous stream according to the group timing information. For example, the group timing information may indicate a scheme in which the conducting device transmits a packet via a broadcast isochronous stream, then a first audio source subsequently transmits a packet via another broadcast isochronous stream, then a second audio source subsequently transmits a packet via another broadcast isochronous stream, and so on until all of the audio sources in the VBIG have transmitted a packet. The group timing information ensures that packet transmissions are time-aligned.

In another example, the conducting device is used to relay the packets to the audio sources by synchronizing non-broadcast streams, such as point-to-point streams or unicast streams. In this example, each of the audio sources transmits packets to the conducting device via individual connected isochronous streams (“CISs”). Broadly, the conducting device may synchronize the timing of the individual CISs with the timing of the VBIG to ensure that the transmissions of audio sources and the conducting device use as little airtime as possible. The conducting device then relays the packets to the plurality of audio devices in a time-aligned manner according to the group timing information. In one example, the conducting device mixes the packets into a single stream according to the group timing information, and then transmits the single stream as a single broadcast isochronous stream. In other examples, the conducting device transmits a series of time-aligned broadcast isochronous streams, each stream corresponding to a different audio source which generated the packet to be relayed. In even further examples, the conducting device relays the packets to the audio sources in a series of connected isochronous streams.

Generally, in one aspect, a system for synchronizing a plurality of isochronous streams is provided. The system includes a first audio source of a plurality of audio sources. The first audio source is configured to transmit a first stream packet of a first isochronous stream of the plurality of isochronous streams according to group timing information. The first stream packet corresponds to the first audio source.

The first audio source is further configured to receive a second stream packet of a second isochronous stream of the plurality of isochronous streams according to the group timing information. The second stream packet corresponds to a second audio source of the plurality of audio sources. According to an example, the first audio source and/or the second audio source may be a set of headphones, an earbud, an audio headset, a set of audio eyeglasses, or a speaker.

The system further includes a conducting device. The conducting device is configured to transmit the group timing information to the first audio source and the second audio source. The plurality of isochronous streams are synchronized to form an isochronous group. According to an example, the conducting device is an in-vehicle infotainment system, a television, or a speaker.

According to an example, the conducting device provides the group timing information via a periodic advertisement transmitted to the first audio source and the second audio source.

According to an example the second stream packet includes destination data. The destination data corresponds to at least one of the plurality of audio sources. The first audio source may render audio corresponding to the second stream packet if the destination data corresponds to the first audio source. The first audio source may disable reception of the second stream packet if the destination data does not correspond to the first audio source.

According to an example, the first stream packet corresponds to audio captured by the first audio source.

According to an example, the second stream packet corresponds to audio captured by the second audio source.

According to an example, the first audio source transmits the first stream packet to the second audio source via the first isochronous stream according to the group timing information. The first isochronous stream is a broadcast isochronous stream. The second audio source may transmit the second stream packet to the first audio source via the second isochronous stream according to the group timing information. The second isochronous stream may be a broadcast isochronous stream. The first stream packet may be transmitted at a first time. The second stream packet may be transmitted at second time subsequent to the first time. The conducting device may transmit a third stream packet of a third isochronous stream to the first audio source and the second audio source at a third time prior to the first time.

According to an example, the first audio source transmits the first stream packet to the conducting device via the first isochronous stream according to the group timing information. The first isochronous stream is a connected isochronous stream. The second audio source may transmit the second stream packet to the conducting device via a third isochronous stream of the plurality of isochronous streams according to the group timing information. The third isochronous stream may be a connected isochronous stream. According to an example, the conducting device transmits the first stream packet to the second audio source via a fourth isochronous stream of the plurality of isochronous streams according to the group timing information. The fourth isochronous stream may be a broadcast isochronous stream. Further to this example, the conducting device may transmit the second stream packet to the first audio source via the second isochronous stream according to the group timing information. The second isochronous stream may be a broadcast isochronous stream. According to another example, the conducting device transmits the first stream packet to the second audio source via a fourth isochronous stream of the plurality of isochronous streams according to the group timing information. The fourth isochronous stream may be a connected isochronous stream. Further to this example, the conducting device transmits the second stream packet to the first audio source via the second isochronous stream according to the group timing information. The second isochronous stream is a connected isochronous stream.

Generally, in another aspect, a method for synchronizing a plurality of isochronous streams is provided. The method includes (1) transmitting, via a conducting device, group timing information to a first audio source and a second audio source; (2) transmitting, via the first audio source, a first stream packet of a first isochronous stream of the plurality of isochronous streams according to the group timing information, wherein the first isochronous stream corresponds to the first audio source; and (3) receiving, via the first audio source, a second stream packet of a second isochronous stream of the plurality of isochronous streams according to the group timing information, wherein the second isochronous stream corresponds to the second audio source. The plurality of isochronous streams are synchronized to form an isochronous group.

According to an example, the method may further include rendering, via the first audio source, audio corresponding to the second stream packet if the second stream packet comprises destination data corresponding to the first audio source.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also can appear in any disclosure incorporated by reference should be accorded a meaning most consistent with the particular concepts disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic view of a system according to the present disclosure illustrating various types of audio sources.

FIG. 2 is a schematic view of a system according to the present disclosure wherein audio sources communicate directly with each other via broadcast isochronous streams.

FIG. 3 is a schematic illustration of a data packet according to the present disclosure.

FIG. 4 is a flow diagram illustrating a first example wireless transmission topology of the system of FIG. 2.

FIG. 5 is a flow diagram illustrating a second example wireless transmission topology of the system of FIG. 2.

FIG. 6 is a schematic view of a system according to the present disclosure wherein audio sources indirectly communicate with each other via a conducting device.

FIG. 7 is a flow diagram illustrating an example wireless transmission topology of the system of FIG. 6.

FIG. 8 is a schematic view of a variation of the system according to the present disclosure wherein audio sources indirectly communicate with each other via a conducting device.

FIG. 9 is a flow diagram illustrating a first example wireless transmission topology of the system of FIG. 8.

FIG. 10 is a flow diagram illustrating a second example wireless transmission topology of the system of FIG. 8.

FIG. 11 is a schematic view of a variation of the system of FIG. 8 wherein audio sources indirectly communicate with each other via a conducting device.

FIG. 12 is a flow diagram illustrating a wireless transmission topology of the system of FIG. 11.

FIG. 13 is a schematic view of a further variation of the system according to the present disclosure wherein audio sources indirectly communicate with each other via a conducting device.

FIG. 14 is a flow diagram illustrating a wireless transmission topology of the system of FIG. 13.

FIG. 15 is a schematic view of components of an audio source according to aspects of the present disclosure.

FIG. 16 is a schematic view of components of a conducting device according to aspects of the present disclosure.

FIG. 17 illustrates steps of a method according to the present disclosure.

### DETAILED DESCRIPTION OF EMBODIMENTS

The present disclosure provides systems and methods for synchronizing isochronous streams. The system includes a plurality of audio sources and a conducting device. Each of the plurality of audio sources is a device configured to stream packets of audio data to the other audio sources via one or more isochronous streams. The audio data may correspond to audio captured by an audio sensor of the audio source, such as a microphone, or to audio provided to the audio source via an external source, such as a smartphone or a remote server. The conducting device is configured to provide group timing information to the plurality of audio sources. In some examples, the conducting device may also serve as an additional audio source. Each of the plurality of audio sources transmits packets of audio data in a time-aligned manner according to the group timing information to avoid interference. Accordingly, the plurality of isochronous streams are synchronized to form an isochronous group of isochronous streams, enabling each audio source to receive data packets from each stream.

The term “wearable audio device” as used in this disclosure, in addition to including its ordinary meaning or its meaning known to those skilled in the art, is intended to mean a device that fits around, on, in, or near an car (including open-car audio devices worn on the head or shoulders of a user) and that radiates acoustic energy into or towards the car. Wearable audio devices are sometimes referred to as headphones, earphones, earpieces, headsets, earbuds or sport headphones, and can be wired or wireless. A wearable audio device includes an acoustic driver to transduce audio signals to acoustic energy. The acoustic driver can be housed in an earcup. While some of the figures and descriptions following can show a single wearable audio device, having a pair of earcups (each including an acoustic driver) it should be appreciated that a wearable audio device can be a single stand-alone unit having only one earcup. Each earcup of the wearable audio device can be connected mechanically to another earcup or headphone, for example by a headband and/or by leads that conduct audio signals to an acoustic driver in the car cup or headphone. A wearable audio device can include components for wirelessly receiving audio signals. A wearable audio device can include components of an active noise reduction (ANR) system. Wearable audio devices can also include other functionality such as a microphone so that they can function as a headset. In some examples, the wearable audio device can be an open-ear device that includes an acoustic driver to radiate acoustic energy towards the car while leaving the car open to its environment and surroundings.

The term “connected isochronous stream” as used in this disclosure, in addition to including its ordinary meaning or its meaning known to those skilled in the art, is intended to refer to an isochronous data stream which utilizes a preestablished, point-to-point communication link over LE Audio between, e.g., a source device (which may also be known as a central or master device) and an audio device or a plurality of audio devices (which may also be known as a peripheral or slave device(s)). In other words, a connected isochronous stream can provide an isochronous audio stream which utilizes at least one established reliable communication channel and/or at least one acknowledged communication channel between the source device and any respective audio devices.

The term “broadcast isochronous stream” as used in this application, in addition to including its ordinary meaning or its meaning known to those skilled in the art, is intended to refer to an isochronous data stream which does not require a preestablished communications link to be established between the source device sending data and the audio device receiving data and does not require acknowledgements or negative acknowledgements to be sent or received.

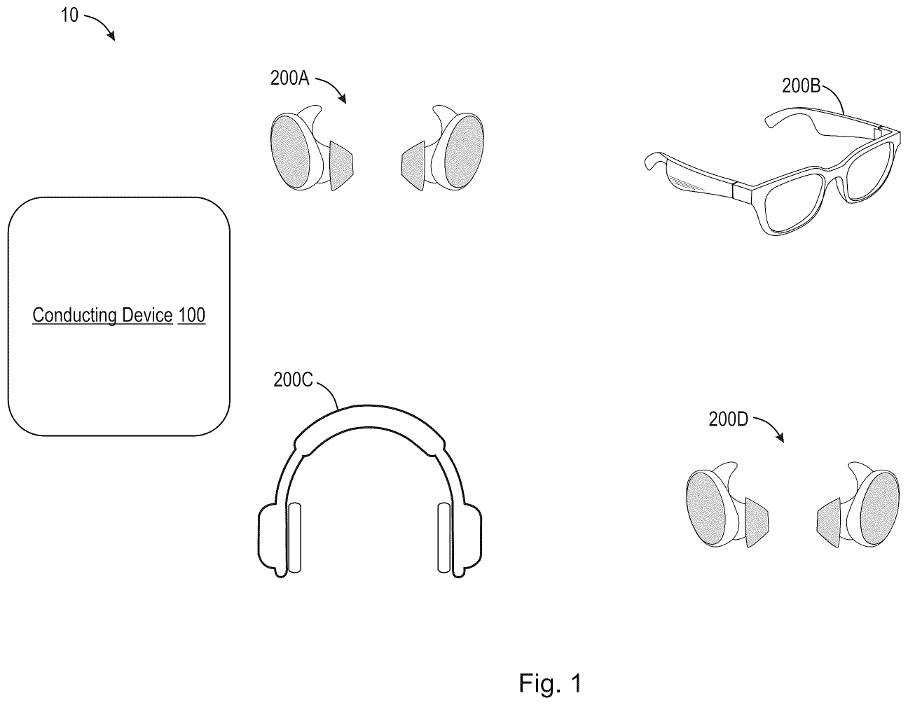

The following description should be read in view of FIGS. 1-17. FIG. 1 is a schematic view of the components of system 10 according to the present disclosure. The system 10 includes a conducting device 100 and a plurality of audio sources 200a-d. Broadly, the system 10 is configured to enable users to communicate with each other via the audio sources 200a-d while, in some examples, also receiving an audio stream from the conducting device 100, functioning as a configurable intercom system.

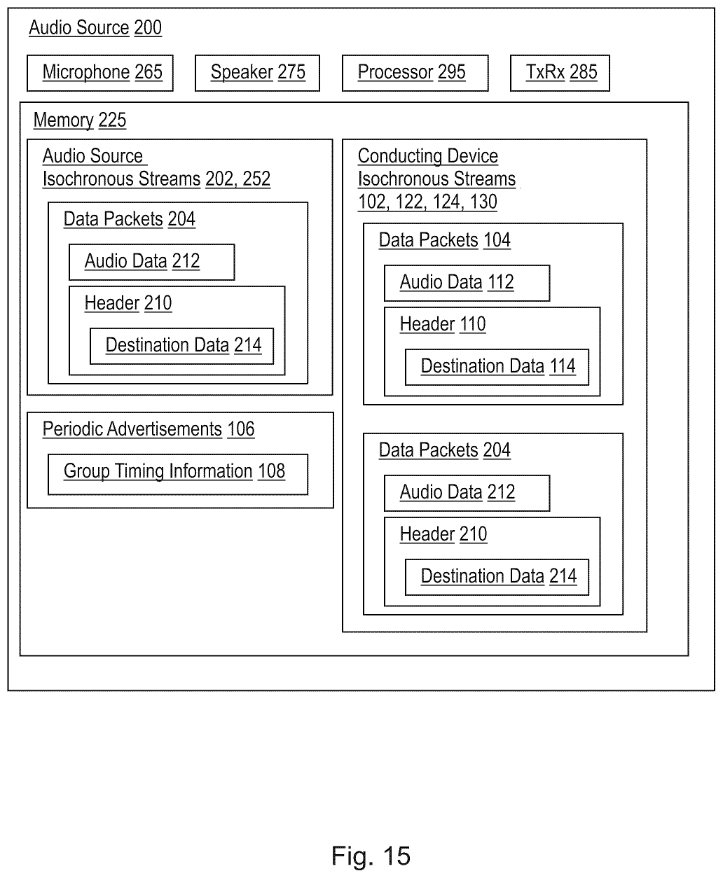

The audio sources 200a-d are configured to capture audio, and to then provide the captured audio to one or more other audio sources 200a-d via isochronous streams in a time-aligned manner. While the non-limiting examples of FIGS. 1-17 depict the isochronous streams as connected isochronous streams or broadcast isochronous streams, other types of isochronous streams may be used where appropriate. As illustrated in FIG. 15, the non-limiting examples of the audio sources 200a-d each include a memory 225, a microphone 265, a speaker 275, a transceiver 285, and a processor 295. Accordingly, the audio sources 200a-d are configured to capture audio (such as via their microphones 265a-d), transmit data packets corresponding to the captured audio, receive data packets containing audio data corresponding to other components of the system 10, and render audio to a user based on the received data packets. In the non-limiting example of FIG. 1, the first audio source 200a is a set of wireless earbuds, the second audio source 200b is a set of audio eyeglasses, the third audio source 200c is a set of audio headphones 200c, and the fourth audio source 200d is a set of wireless earbuds (distinct from the first audio source 200a). In other examples, the audio sources 200a-d may be any audio device capable of capturing audio, wirelessly transmitting audio data, wirelessly receiving audio data, and rendering audio. For example, the audio sources 200a-d may be any of the wearable audio devices described above. In further examples, one or more of the audio sources 200a-d may be a non-wearable audio device, such as a speaker or a stage microphone. The system 10 may include any practical number of audio sources 200.

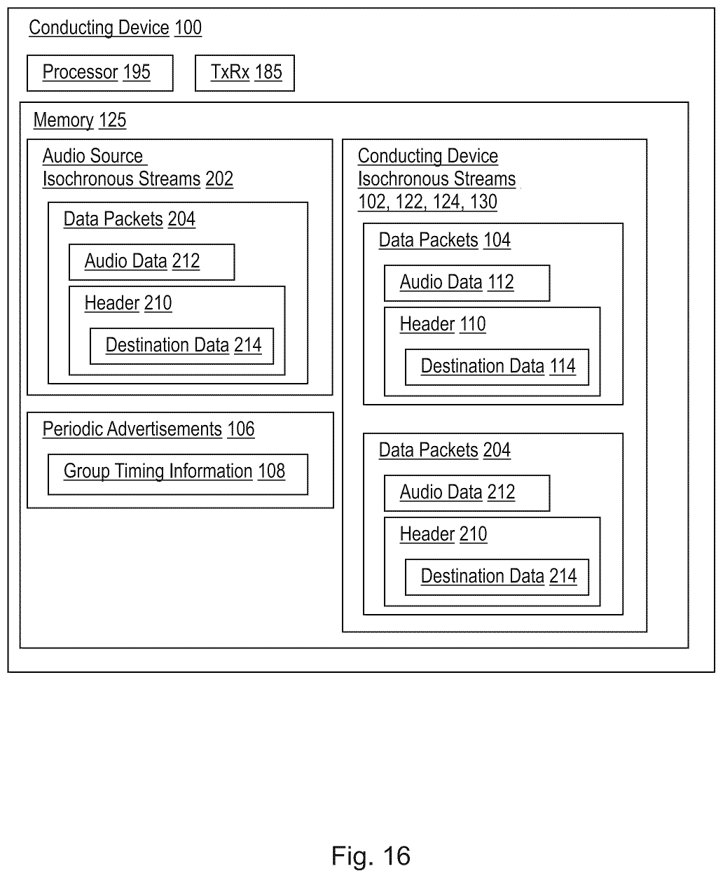

As illustrated in FIG. 16, the non-limiting example of the conducting device 100 includes a memory 125, a transceiver 185, and a processor 195. The conducting device 100 is configured to time-align the isochronous streams of the data captured by the audio source 200a-d. The conducting device 100 may be a wide array of devices, such as a television, a speaker, an in-vehicle infotainment system, etc. In further examples, the conducting device 100 could also be a wearable audio device such as a set of wireless earbuds, a set of audio eyeglasses, or a set of audio headphones.

The system 10 of FIG. 1 may be implemented in a wide variety of environments. In one non-limiting example, the conducting device 100 may be an infotainment system of a motor vehicle, while the audio sources 200a-d are various types of wearable audio devices worn by passengers of the vehicle. In this example, the infotainment system may provide an audio stream to the audio sources 200a-d corresponding to one or more of a wide variety of external audio sources, such as radio, television, telephone, navigation system, emergency service, physical media (audio cassette, video cassette, compact disc, digital video disc, Blu-ray, etc.), external storage devices (USB flash drive, smartphone, tablet computer, portable media player, etc.), etc. While the passengers receive the audio stream via their associated audio sources 200a-d, they may also communicate with each other via the microphones 265a-d and speakers 275a-d of the audio sources 200a-d in an intercom-like fashion. In one example, the microphone 265a of the first audio source 200a (depicted as a set of wireless earbuds) may capture voice audio spoken by the passenger. Audio data corresponding to the captured voice audio is then streamed to one or more of the other audio sources 200b-d, which subsequently render the voice audio data (along with the audio stream from the infotainment system) via speakers 275b-d. The voice audio data and the infotainment audio stream are transmitted to the audio sources 200b-d in a time-aligned manner to avoid interference.

In another non-limiting example, the conducting device 100 may be a television in a sports bar televising a sporting event. In this example, patrons of the sports bar may listen to an audio stream from the television via the audio sources 200a-d. These audio sources 200a-d may be particularly useful for patrons experiencing hearing loss, or if the crowd-noise within the sports bar partially obscures audio playback of the television, or if the audio volume of multiple televisions showing different programming within the same sports bar is turned down to avoid audio interference from one television to the next. Further, similar to the motor vehicle example, the patrons may also communicate with each other via their audio sources 200a-d in an intercom-like manner. In further examples, the system 10 shown in FIG. 1 may be implemented in any environment in which individuals which to communicate with each other via the audio sources 200a-d, such as an office, warehouse, or retail floor setting. In some examples, the conducting device 100 may also serve as an audio source. In even further examples, the system 10 may be implemented in a performance lessen environments (such as a dance studio) where multiple lessens occur simultaneously, each lessen requires a unique audio source, and an instructor must be able to communicate with a pupil.

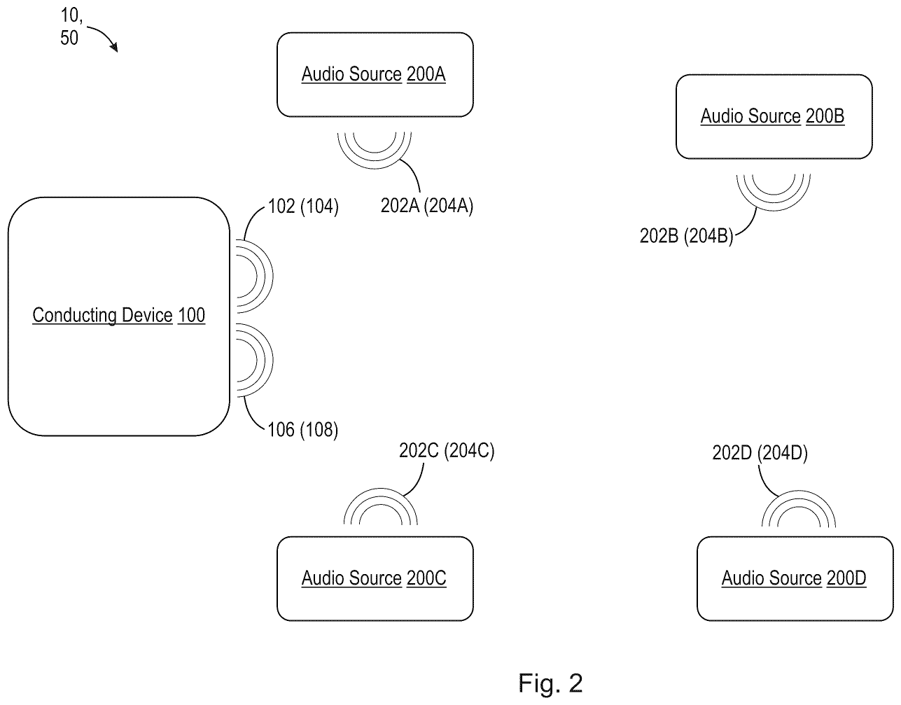

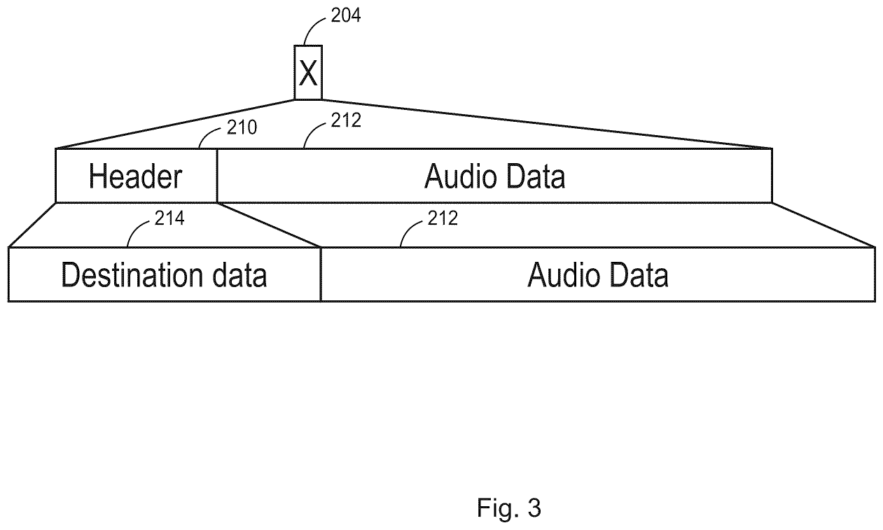

FIG. 2 illustrates an implementation of the system 10 of FIG. 1 where the audio sources 200a-d communicate directly with each other via synchronized and time-aligned broadcast isochronous streams. The plurality of broadcast isochronous streams may be considered an isochronous group 50, such as a virtual broadcast isochronous group (“VBIG”). As shown in this example, each audio source 200a-d transmits a broadcast isochronous stream 202a-d. The broadcast isochronous streams 202a-d each contain a sequential series of data packets 204a-d. An example data packet 204 is shown in more detail in FIG. 3. Each data packet 204a-d includes audio data 212a-d. This audio data 212a-d corresponds to at least voice audio captured by a one or more microphones 265a-d of each audio source 200a-d. For example, the first audio source 200a (such as the set of earbuds shown in FIG. 1) generates a first broadcast isochronous stream 202a. The first broadcast isochronous stream 202a includes a series of data packets 204a. Each data packet 204a includes audio data 212a (such as an audio frame) corresponding to voice audio captured by a microphone 265a arranged on or embedded within the first audio source 200a. The audio data 212a may be a digitized version of the raw audio captured by the microphone 265a, or the audio data 212a may undergo further processing prior to transmission via the first broadcast stream 202a. As a broadcast isochronous stream may be received by more than one receiving device simultaneously, the first broadcast isochronous stream 202a may be received by the second audio source 200b, the third audio source 200c, and/or the fourth audio source 200d.

As further illustrated in FIG. 3, each data packet 204a-d may contain a header 210a-d. The header 210a-d may contain a wide array of data. In the example of FIG. 3, the header 210a-d includes destination data 214a-d. The destination data 214a-d indicates which of the audio sources 200a-d should render the audio data 212a-d of the data packet 204. For example, if the user of the first audio source 200a wishes to communicate with the user of the second audio source 200b (but not the third and fourth audio sources 200c, 200d) the destination data 214a transmitted by the first audio source 200a may indicate that the second audio source 200b should render the audio data 212a of the data packet 204a, but the third and fourth audio sources 200c, 200d should not render the audio data 212a. Accordingly, upon receiving the data packet 204a, the third and fourth audio sources 200c, 200d may simply ignore the audio data 212a or omit the data packet 204a from playback. In some examples where the third and fourth audio sources 200c, 200d are configured to process data relatively quickly, the third and fourth audio sources 200c, 200d may cease receiving the audio data 212a upon processing the destination data 214a.

The destination data 214a-d may be programmed through any practical means, such as a user interface comprising, for example, one or more physical or virtual buttons, associated with the audio sources 200a-d. In some examples, the destination data 214a-d may be programmed according to a voice command spoken by the users of the audio sources 200a-d. In further examples, the destination data 212a-d may be programmed by external devices (such as a smartphone) paired with the audio sources 200a-d. In further examples, an environment may include multiple systems 10 configuring synchronized streams. For example, each television set in a sports bar may be capable of creating a system with a conducting device 100 (the television set) and audio sources 200 (wearable audio devices worn by sports bar patrons). U.S. Pat. No. 11,304,006, incorporated in its entirety by reference, describes methods for choosing one of a plurality of systems 10 in an environment.

As with the audio sources 200a-d, the conducting device 100 is configured to transmit a broadcast isochronous stream 102 to the audio sources 200a-d. The broadcast isochronous stream 102 contains data packets 104 with audio data 112. As previously mentioned, the audio data 112 may correspond to audio from an in-vehicle infotainment system or from a television in a communal viewing environment. In some examples, and as with the audio data 212a-d from the audio sources 200a-d, the data packets 104 may also include header information 110 with destination data 114 dictating which of the audio sources 200a-d may receive and/or render the audio data 112.

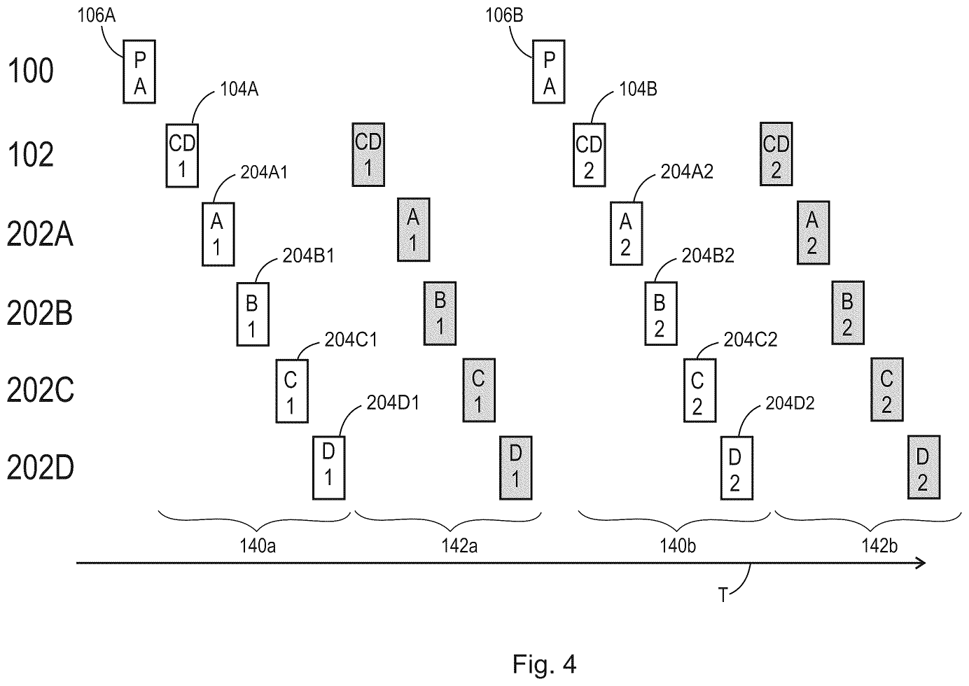

The conducting device 100 is also configured to wirelessly transmit periodic advertisements 106. The periodic advertisements 106 may be transmitted over any practical means of wireless communication, including Bluetooth isochronous streams. The periodic advertisement 106 contains group timing information 108 configured to time-align and synchronize the various streams 102, 202A-D transmitted by the components of the system 10. More specifically, the group timing information 108 controls when each stream 102, 202a-d transmits a data packet 104, 204a-d to avoid interference. More detail regarding the time-alignment is described with respect to FIG. 4. The periodic advertisements 106 are received by the audio sources 200a-d. In response, the audio sources 200a-d may transmit an acknowledgement packet to the conducting device indicating that the audio source 200a-d will begin transmitting data according to the group timing information 108. In other examples, the audio sources 200a-d may simply begin transmitting data according to the group timing information 108. Upon receiving an acknowledgement packet or data packets 204a-d containing audio data 212, the conducting device 100 may update the group timing information 108 to reflect the number of active streams 102, 202a-d in the system 100. Similarly, the conducting device 100 may also update the group timing information 108 to reflect that an audio source 200a-d is no longer transmitting a stream 202a-d within range of the conducting device 100. This may occur due to the audio source 200a-d being deactivated or moved away from the conducting device 100.

Generally, the group timing information 108 provided by the conducting device 100 may be used to synchronize broadcast or non-broadcast isochronous streams. The non-broadcast isochronous streams could include unicast streams, point-to-point streams, device-to-device streams, or connected isochronous streams. Further, in some examples, the group timing information 108 could be used to synchronize the streams of a system including both broadcast and non-broadcast isochronous streams. In even further examples, the group timing information 108 could be used to synchronize broadcast streams with non-LE Audio streams, such as Bluetooth Classic streams, Wi-Fi streams, etc.

FIG. 4 is a flow diagram illustrating a wireless transmission topology of the system 10 of FIG. 2. The topology includes a broadcast isochronous stream 102 transmitted by the conducting device 100. The broadcast isochronous stream 102 includes a plurality of data packets 104. The topology further includes a plurality of broadcast isochronous streams 202a-d transmitted by the audio sources 200a-d. Each of the plurality of broadcast isochronous streams 202a-d also includes a plurality of data packets 204a-d. The topology further includes periodic advertisements 106 transmitted by the conducting device 100. The periodic advertisements 106 include group timing information 108 configured to time-align the isochronous streams 102, 202a-d such that one or more of the audio sources 200a-d may successfully receive all of the data packets 104, 204a-d of each stream 102, 202a-d.

Following along a timeline T of the system 10, a first periodic advertisement 106a is wirelessly transmitted by the conducting device 100. The first periodic advertisement 106a includes group timing information 108 configured to time-align the broadcast isochronous streams 102, 202a-d of the system 10. The first periodic advertisement 106a is transmitted such that any audio source 200a-d within transmission range of the conducting device 100 may receive the first periodic advertisement 106a. Upon receiving the first periodic advertisement 106a, each of the audio sources 200a-d may begin transmitting a broadcast isochronous stream 202a-d in a time-aligned manner. Further, the period of the periodic advertisement 106 may be independent of the group timing information 108. For example, following the transmission of the first periodic advertisement 106a, a second periodic advertisement 106b may not be transmitted until each broadcast isochronous stream 102, 202a-d transmits several data packets 104, 204a-d. Further, the period of the periodic advertisement 106a does not necessarily need to be time aligned with the broadcast isochronous streams 102, 202a-d.

Following the transmission of the periodic advertisement 106, the broadcast isochronous stream 102 of the conducting device 100 transmits a first data packet 104a. This first data packet 104a may be received and rendered by each audio source 202a-d in the system 10. In some examples, the receiving and/or rendering of the first data packet 104a may be controlled by destination data 114a in the header 110a of the first data packet 104a.

Once the transmission of the first data packet 104a from the conducting device 100 is complete, the broadcast isochronous stream 202a of the first audio source 200a then transmits a first data packet 204a1. This first data packet 204a1 is to be received and rendered by the other audio sources 202b-d in the system 10 corresponding to the destination data 214a1 of the header 210a1 of the first data packet 204a1. The conducting device 100 may also receive the first data packet 204a1, and may update the group timing information 108 to account for the active broadcast isochronous stream 202a transmitted by the first audio source 200a.

Once the transmission of the first data packet 204a1 from the first audio source 200a is complete, the broadcast isochronous stream 202b of the second audio source 200b then transmits a first data packet 204b1. This first data packet 204b1 is to be received and rendered by the other audio sources 200a, 200c, 200d in the system 10 corresponding to the destination data 214b1 of the header 210b1 of the second data packet 204b1. The conducting device 100 may also receive the first data packet 204b1, and may update the group timing information 108 to account for the active broadcast isochronous stream 202b transmitted by the second audio source 200b.

Once the transmission of the first data packet 204b1 from the second audio source 200b is complete, the broadcast isochronous stream 202c of the third audio source 200c then transmits a first data packet 204cl. This first data packet 204cl is to be received and rendered by the other audio sources 200a, 200b, 200d in the system 10 corresponding to the destination data 214cl of the header 210cl of the third data packet 204cl. The conducting device 100 may also receive the first data packet 204cl, and may update the group timing information 108 to account for the active broadcast isochronous stream 202c transmitted by the third audio source 200c.

Once the transmission of the first data packet 204cl from the third audio source 200c is complete, the broadcast isochronous stream 202d of the fourth audio source 200d transmits a first data packet 204d1. This first data packet 204d1 is to be received and rendered by the other audio sources 202a-c in the system 10 corresponding to the destination data 214d1 of the header 210d1 of the first data packet 204d1. The conducting device 100 may also receive the first data packet 204d1, and may update the group timing information 108 to account for the active broadcast isochronous stream 202d transmitted by the fourth audio source 200d.

The time-aligned transmission of the first data packets 104a, 204a1, 204b1, 204cl, 204d1 may be considered a first transmission cycle 140a. Following the first transmission cycle 140, and as illustrated in FIG. 4, an optional first retransmission cycle 142a may occur. In the first retransmission cycle 142a, each of the first data packets 104a, 204a1, 204b1, 204c1, 204d1 are transmitted again in the same time-alignment and sequential order as in the first transmission cycle 140a. The first retransmission cycle 142a is useful in case of temporary interface or other temporary transmission or reception issues during the first transmission cycle 140a. In some examples, the first transmission cycle 140a may be followed by a plurality of retransmission cycles 142a duplicating the first transmission cycle 140a.

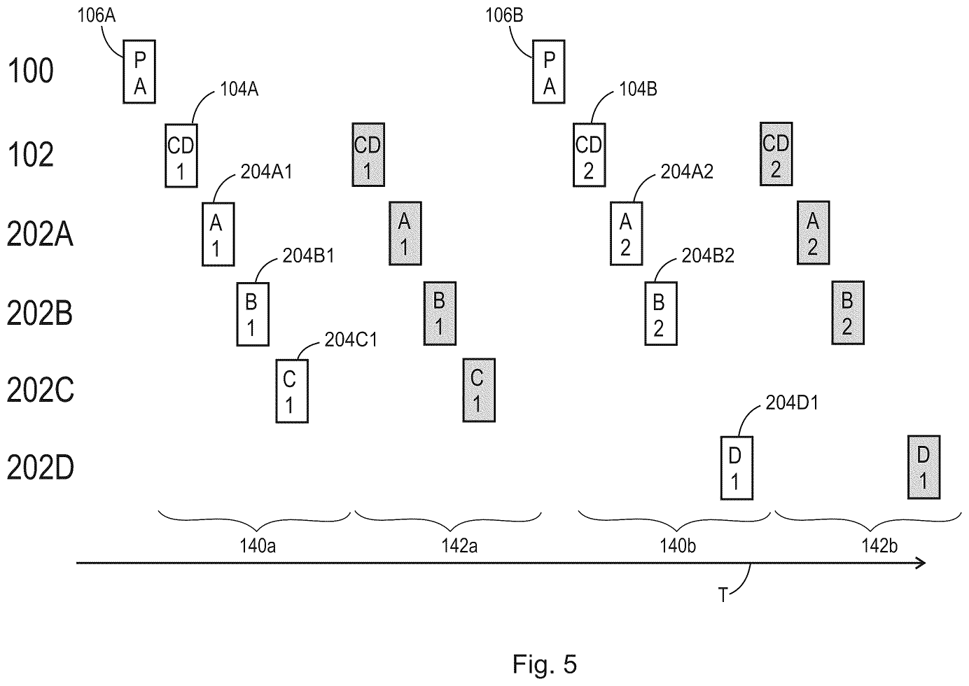

Following the first retransmission cycle 142a, the conducting device 100 transmits a second periodic advertisement 106b. The second periodic advertisement 106b is transmitted to provide updated group timing information 108. The updated group timing information 108 may account for the presence of new audio sources 200 in the system 10, or if any audio sources 200 have left the system 10. The determination of the presence of audio sources 200 within the system 10 may be based on data packets 204 or advertisement packets transmitted (or not transmitted) by the audio sources 200 and received (or not received) by the conducting device 100. The result of audio sources 200 entering or leaving the system 10 is described in more detail with reference to FIG. 5. In other examples, the conducting device 100 transmits the periodic advertisement 106 less frequently than illustrated in FIG. 4, such as every two, three, or four transmission cycles 140 and/or retransmission cycles 142. In even further examples, the transmission cycle of the periodic advertisements 106 may be unrelated to the transmission cycles 140 and retransmission cycles 142 shown in FIG. 4.

Subsequent to the transmission of the second periodic advertisement 106b, the second transmission cycle 140b begins. As the group of audio devices 200a-d (and therefore the virtual broadcast isochronous group) remains the same from the first periodic advertisement 106a, the second transmission cycle 140b includes the transmission of the second data packets 104b, 204a2, 204b2, 204c2, 204d2 of the broadcast isochronous streams 102, 202a-d in the same sequential order and time-alignment as the first transmission cycle 140a. The second retransmission cycle 142b then follows the second transmission cycle 140b, wherein each of the second data packets 104b, 204a2, 204b2, 204c2, 204d2 are transmitted again in the same time-aligned manner as in the second retransmission cycle 142b.

FIG. 5 illustrates a variation of the flow diagram of FIG. 4. However, in FIG. 5, the fourth audio source 200d is not active and/or present within the system 10 during the transmission of the first periodic advertisement 106a. Thus the first transmission and retransmission cycles 140a, 142a do not include a data packet transmitted by the fourth audio source 202d. The group timing information 108a, configured to align the transmission of five data packets, therefore leaves the last sequential transmission “slot” open. In some examples, the conducting device 100 learns of the open slot through regular scanning of the isochronous streams 202a-d. In other examples, the conducting device 100 relies on advertisement packets transmitted by the audio sources 200a-d to determine if an audio source 200a-d is active and/or present within the system 10.

The open slot of the first transmission and retransmission cycles 140a, 142a is indicated in the group timing information 108b conveyed with the second periodic advertisement 106b. In the time between the transmission of the first and second periodic advertisements 106a, 106b, the fourth audio source 200d has been activated and positioned within transmission range of the conducting device 100, thus joining the system 10. The fourth audio source 200d therefore receives the second periodic advertisement 106b conveying the group timing information 108b, configuring the fourth audio source 200d to transmit data packets 204d of the broadcast isochronous stream 202d during the last sequential slot. Accordingly, FIG. 5 illustrates the transmission of a first data packet 204d1 of the broadcast isochronous stream 202d of the fourth audio source 202d during the second transmission cycle 140b. The first data packet 204d1 is then retransmitted during the second retransmission cycle 142b.

Further, prior to the fourth sequential slot of the second transmission cycle 140b, the third audio source 200c is deactivated, moved out of wireless transmission range of the other components of the system 10, or has no more data packets 204c to transmit. Therefore, the conducting device 100 will update the group timing information 108b to reflect that the third sequential slot of the second transmission cycle 140b is now open. Accordingly, if a new audio source 200 joins the system 10 in subsequent transmission cycles 140, the group timing information 108 will configure the audio source 200 to transmit data packets 204 during the third sequential slot, thus designating the third sequential slot for transmissions by the new audio source 200.

The determination that an audio source 200 has been deactivated, moved out of wireless transmission range, otherwise no longer able to communicate with the system 10 may be determined based on a set of predefined criteria. If, for example, the audio source 200 is in transmission range of the other components of the system 10, the audio source 200 may indicate (such as via a header 210) that it no longer has any audio data 212 to transmit. If the audio source 200 have been deactivated or is no longer in transmission range, the predefined criteria could include a period of time where a lack a data (such as data packets 204 or advertisements) received by a conducting device 100 indicates an open slot.

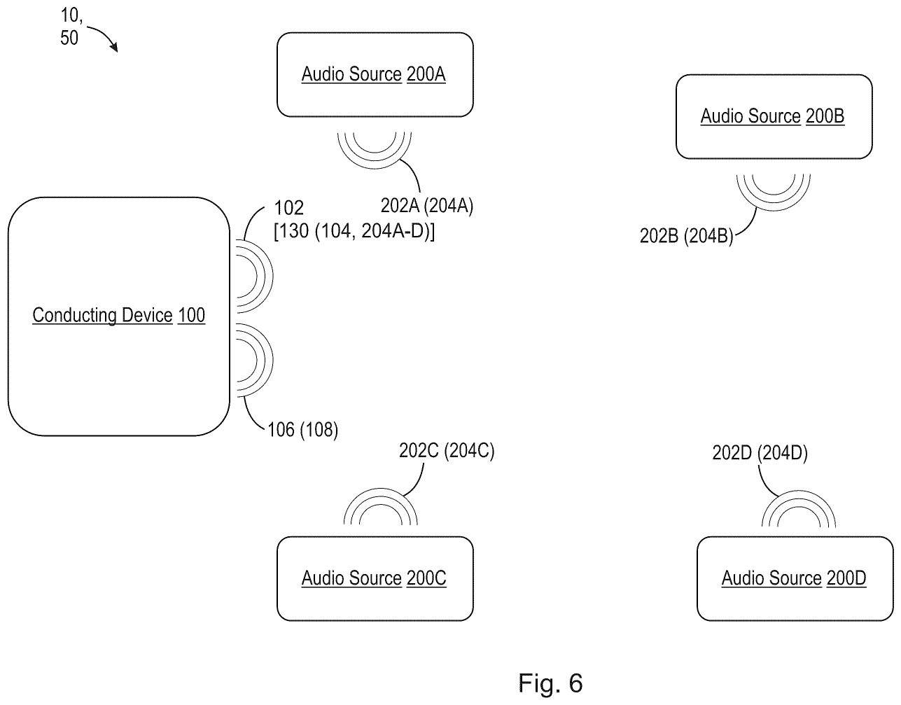

FIG. 6 illustrates a variation of the system of FIG. 2 where the conducting device 100 acts as an intermediary to relay data packets between the audio sources 200a-d. In the non-limiting example of FIG. 6, each audio source 200a-d transmits data packets 204a-d via broadcast isochronous streams 202a-d. However, in the example of FIG. 6, the audio sources 200a-d are not configured to receive the data packets 204a-d directly from the other audio sources 200a-d. For example, the destination data 214a-d associated with each data packet 204a-d may indicate that only the conducting device 100 is configured to or capable of receiving the data packets 204a-d transmitted by the audio sources 204a-d. Upon receiving the data packets 204a-d, the conducting device 100 mixes the data packets 204a-d into a single mixed packet 130. The mixed packet 130 is a combination or blend of the data packets 204a-d received by the conducting device 100, as well as a data packets 104 generated by the conducting device. Accordingly, in the aforementioned vehicle example, the mixed packet 130 may include a mixed audio frame including audio from a central infotainment system and captured by each person within the vehicle. The mixed packet 130 is then transmitted to each of the audio source 202a-d via the broadcast isochronous stream 102, enabling each audio source 202a-d to receive the mixed packet 130 and render the mixed audio contained within each mixed packet.

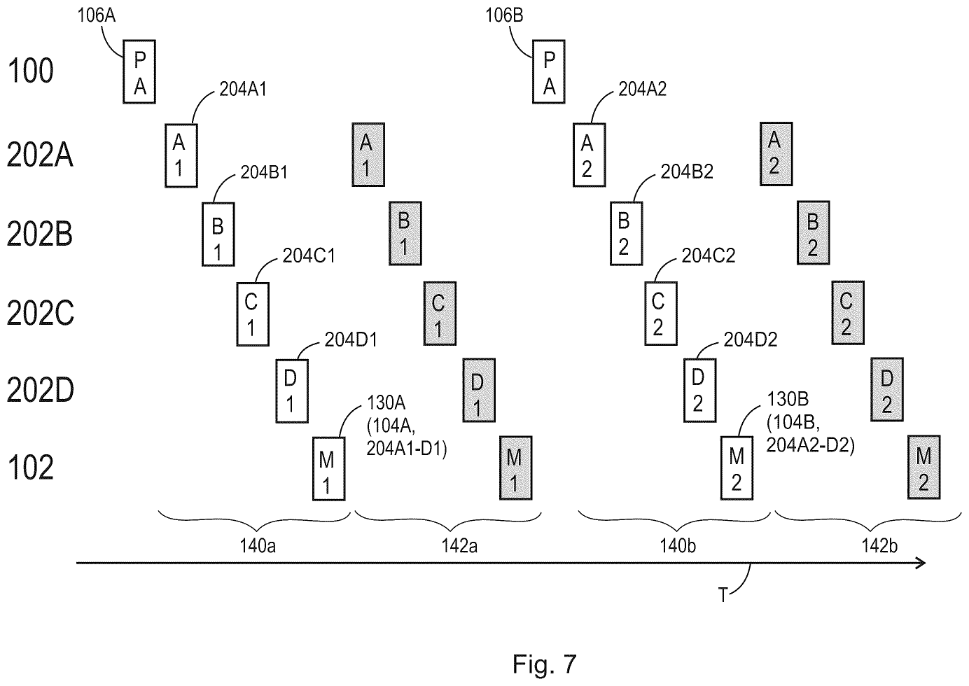

FIG. 7 is a flow diagram illustrating a wireless transmission topology of the system 10 of FIG. 6. In the first transmission cycle 140a, each of the audio sources 200a-d transmits a first data packet 204a1-d1. The conducting device 100 then mixes the data (which may be audio data) contained within the received data packets 204a1-d1 from the audio sources 200a-d with the data (which may also be audio data) of a data packet 104a from the conducting device 100 itself into a single mixed packet 130a. The single mixed packet 130a is then transmitted to the audio sources 202a-202d via the broadcast isochronous stream 102. In some examples, these data packets 204a1-204d1 and the mixed packet 130a may be then retransmitted between the audio sources 200a-d and the conducting device 100 during a first retransmission cycle 142a. This process is then repeated in the second transmission and retransmission cycles 140a, 142b.

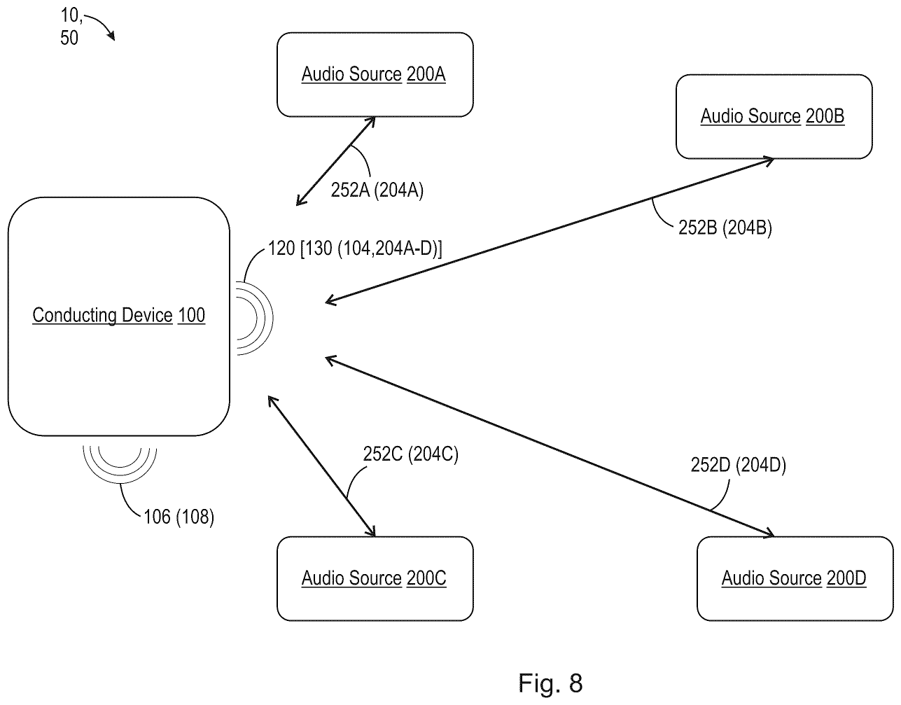

FIG. 8 illustrates another variation of the system of FIG. 2 where the conducting device 100 acts as an intermediary to relay data packets between the audio sources 200a-d. In the non-limiting example of FIG. 8, each audio source 200a-d conveys data packets 204a-d to the conducting device 100 via an isochronous group 50 of unicast or point-to-point streams, embodied as connected isochronous streams 252a-d. These connected isochronous streams 252a-d may be bidirectional. Upon receiving the data packets 204a-d, the conducting device 100 mixes the data packets 204a-d into a mixed packet 130 transmitted via a single broadcast isochronous stream 120 to relay the data packets 204a-d to each of the audio sources 200a-d. The mixed packet 130 may also include data from data packets 104 sourced from the conducting device 100 itself. As with the previous examples, the data packets 104, 204a-d may include headers 110a, 210a-210d with destination data 114a, 214a-d controlling which audio sources 200a-d may receive and/or render the audio data 112a, 212a-d of the data packets 104, 204a-d. As with the previous examples, the conducting device 100 is also configured to wirelessly transmit periodic advertisements 106 to the audio sources 200a-d. The periodic advertisements 106 include group timing information 108 to time-align and synchronize the connected isochronous streams 252a-d transmitted by the audio sources 200a-d and the broadcast isochronous stream 120 transmitted by the conducting device 100.

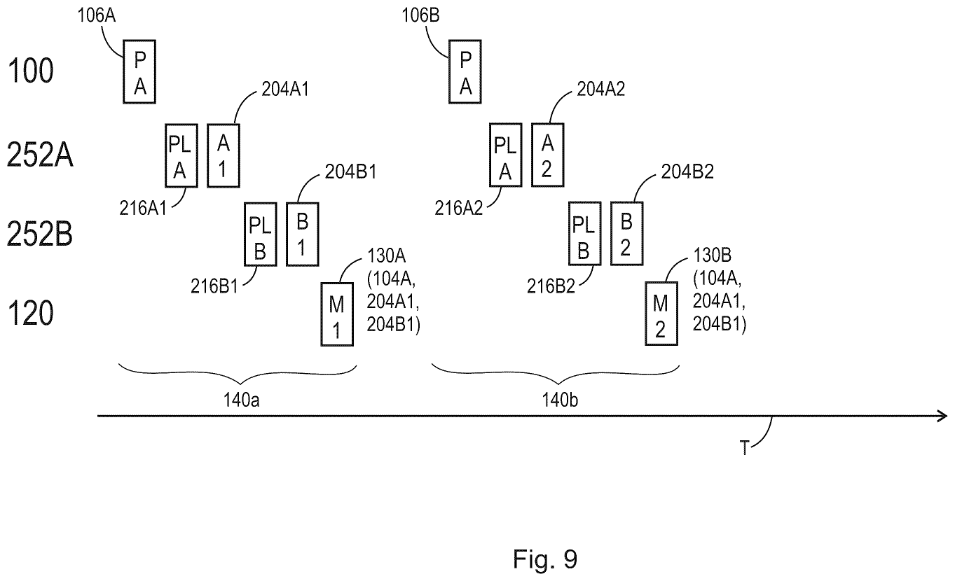

FIG. 9 is a flow diagram illustrating a wireless transmission topology of the system 10 of FIG. 8. For the sake of clarity, the flow diagram of FIG. 9 assumes that the only active devices in the system 10 are the conducting device 100, the first audio source 200a, and the second audio source 200b. Accordingly, any transmissions related to the third or fourth audio sources 200c, 200d are omitted. In the first transmission cycle 140a, the conducting device 100 transmits a poll packet 216a1 to the first audio source 200a. In response to receiving the poll packet 216a1, the first audio source 200a transmits a first data packet 204a1 of a first connected isochronous stream 252a to the conducting device 100. Subsequently, also in response to receiving a poll packet 216b1, the second audio source 200a then transmits a first data packet 204b1 of a second connected isochronous stream 252b to the conducting device 100. The conducting device 100 then mixes the received data packets 204a1, 204b1 from the audio sources 200a, 200b with a data packet 104a from the conducting device 100 itself into a single mixed packet 130a to be transmitted via a single broadcast isochronous stream 120. In some examples, the data packets 204a1, 204b1 and the mixed packet 130a may be then retransmitted between the audio sources 200a, 200b and the conducting device 100 during a first retransmission cycle 142a (not shown). The second data packets 204a2, 204b2 and the second mixed packet 130b are then transmitted between the audio sources 200a, 200b and the conducting device 100 during the second transmission and retransmission cycles 140b, 142b in the same manner as the first transmission cycle 140a.

The aforementioned mixing of data packets 204 by the conducting device 100 may refer to a number of different processes. In one example, the audio data 212 of each data packet 204 may be extracted, decoded, and combined into a single packet carrying all of the audio data 212 of each data packet 204. In this example, a receiving device would be unable to discern between the various sources of the audio data and could only selectively render all or none of the audio channels. In an alternative example, the audio data 212 of each data packet 204 may be multiplexed in such a manner that the receiving device would be able to select which data to render. However, while this multiplexed example provides a greater degree of configurability, it also requires a significant amount of bandwidth.

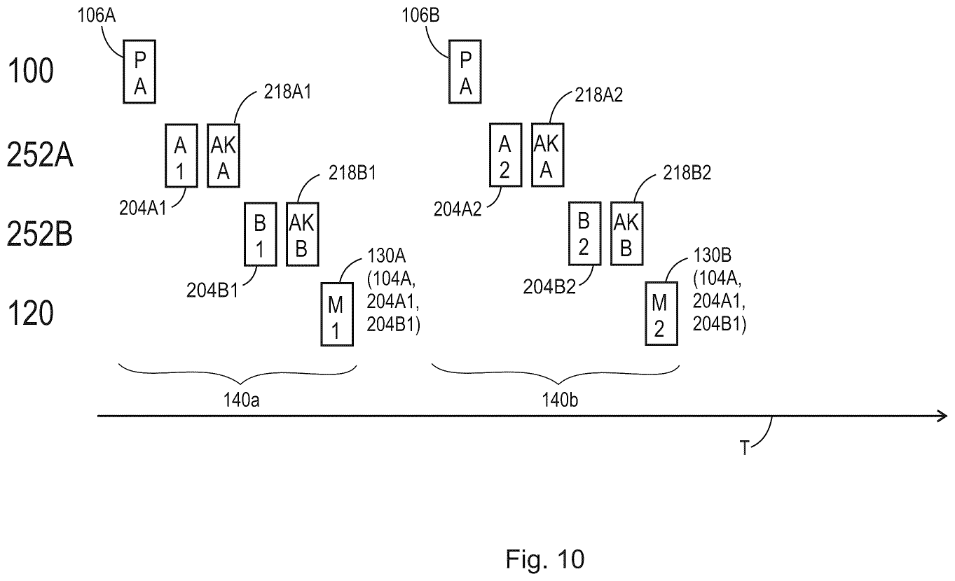

FIG. 10 illustrates a variation of the flow diagram of FIG. 9. In the example of FIG. 10, the audio sources 200a-d do not transmit the data packets 204a-d in response to poll packets 216. Instead, the audio sources 200a-d first transmit the data packets 204a-d via the connected isochronous streams 252, and then receive an acknowledgement packet 218 from the conducting device 100 upon successful receipt. In this configuration, each audio source 200a-d acts a central device dictating the timing of the system 10. As with the example of FIG. 9, once the conducting device 100 receives the data packets 204a-d from of each of the audio sources 200a-d, the conducting device 100 transmits the mixed packet 130 to each of the audio sources 200a-d.

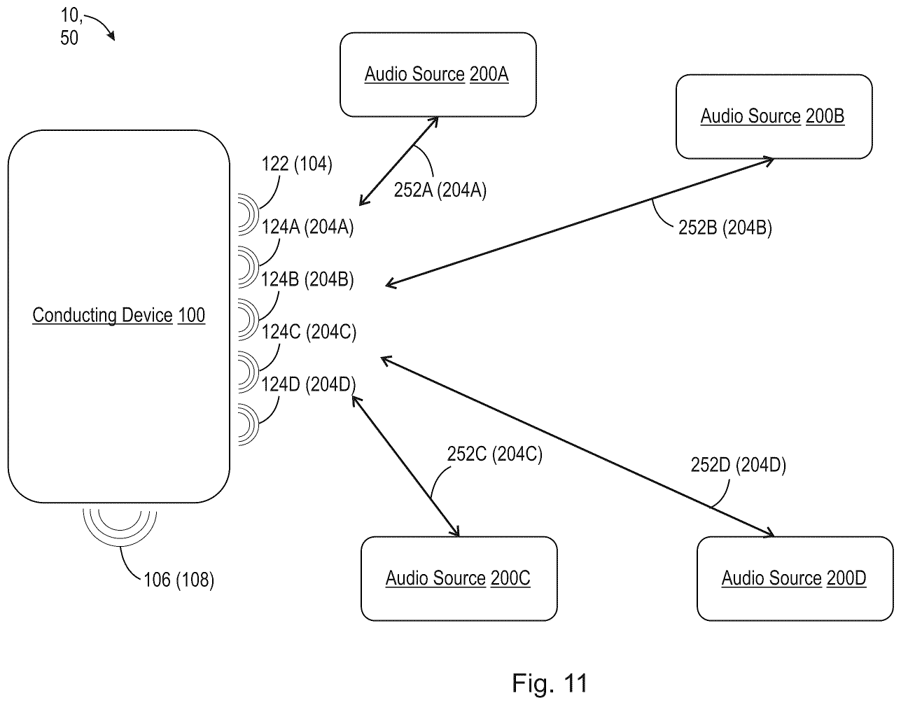

FIG. 11 illustrates a variation of the system 10 of FIG. 10. In FIG. 11, rather than mixing the data packets 104, 204a-d into a single packet 130, the conducting device 100 transmits the data packets 104, 204a-d in individual broadcast isochronous streams 122, 124a-d according to their origin. In FIG. 11, the conducting device 100 generates five broadcast isochronous streams 122, 124a-d. A first broadcast isochronous stream 122 conveys data packets 104 originating from the conducting device 100. A second broadcast isochronous stream 124a conveys data packets 204a originating from the first audio source 200a. A third broadcast isochronous stream 124b conveys data packets 204b originating from the second audio source 200b. A fourth broadcast isochronous stream 124c conveys data packets 204c originating from the third audio source 200c. A fifth broadcast isochronous stream 124d conveys data packets 204d originating from the fourth audio source 200d.

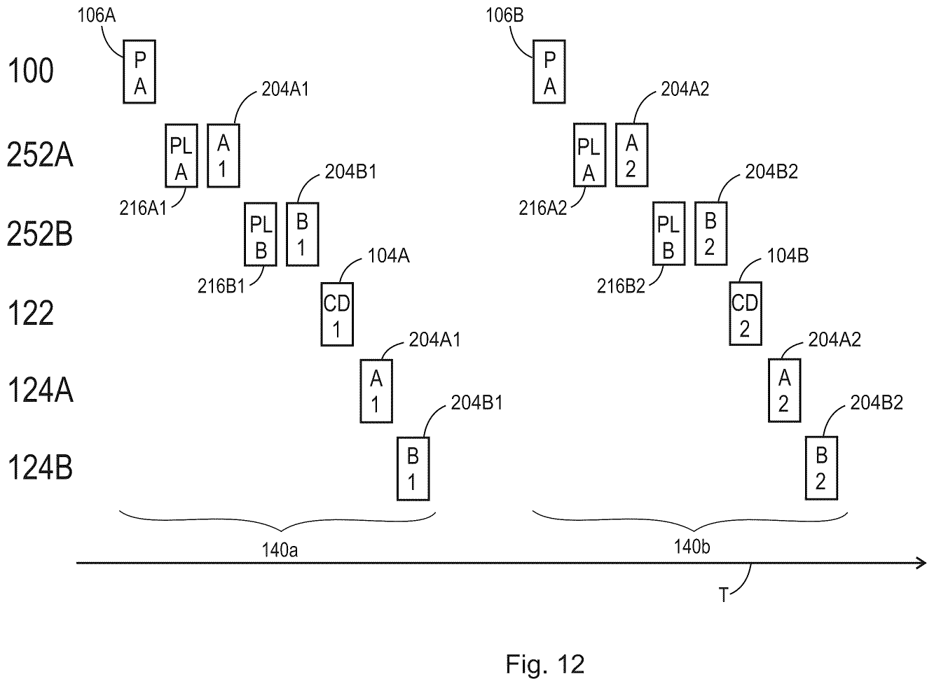

FIG. 12 is a flow diagram illustrating a wireless transmission topology of the system 10 of FIG. 11. As with FIG. 9, for the sake of clarity, the flow diagram of FIG. 12 assumes that the only active devices in the system 10 are the conducting device 100, the first audio source 200a, and the second audio source 200b. Accordingly, any transmissions related to the third or fourth audio sources 200c, 200d are omitted. Further, also like FIGS. 9 and 10, FIG. 12 omits retransmission cycles 142a, 142b. In the first transmission cycle 140a, in response to receiving a poll packet 216a1, the first audio source 200a transmits a first data packet 204a1 of a first connected isochronous stream 252a to the conducting device 100. Subsequently, the second audio source 200b then transmits, in response to receiving a poll packet 216b1, a first data packet 204b1 of a second connected isochronous stream 252b to the conducting device 100.

However, rather than mixing the received data packets 204a1, 204b1 from the audio sources 200a, 200b with a data packet 104a from the conducting device 100, the conducting device 100 transmits the packets 104a, 204a1, 204b1 via individual broadcast isochronous streams 122, 124a, 124b. Accordingly, as seen in FIG. 12, during the first transmission cycle 140a, the first data packet 104a (originating from the conducting device 100) is transmitted via the first broadcast isochronous stream 122 to both the first and second audio sources 200a, 200b. The first data packet 204a1 originating from the first audio source 200a is transmitted via the second broadcast isochronous stream 124a. The first data packet 204b1 originating from the second audio source 200b is transmitted via the third broadcast isochronous stream 124b. These data packets 104a, 204a1, 204b1 are then retransmitted between the audio sources 200a, 200b and the conducting device 100 during the first retransmission cycle 142a (not shown). The second data packets 104b, 204a2, 204b2 are then transmitted between the audio sources 200a, 200b and the conducting device 100 during the second transmission cycle 140b in the same manner as the first transmission cycle 140a.

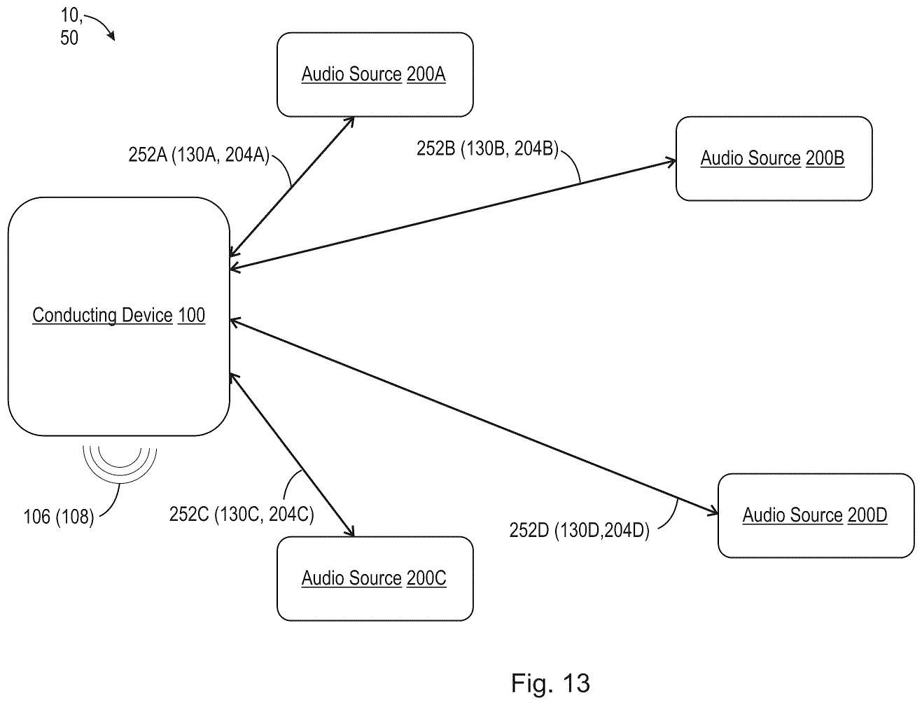

FIG. 13 illustrates a further variation of the systems 10 of FIGS. 8 and 11. In FIG. 13, the conducting device 100 mixes the data packets 104, 204a-d into mixed packets 130a-d. The mixed packets 130 are then transmitted via a plurality of bidirectional connected isochronous streams 252a-d, rather than the plurality of broadcast isochronous streams 124a-d of FIG. 11. In FIG. 13, the conducting device 100 forms four bidirectional connected isochronous streams 252a-d corresponding to the four audio sources 200a-d. Each connected isochronous stream 252a-d conveys the mixed data packets 130a-d to one of the audio sources 200a-d. Accordingly, while the previous examples illustrated the conducting device 100 transmitting data packets 104, 204a-d or mixed packets 130 to the audio sources 200a-d via one or more “one-to-many” broadcast isochronous streams, FIG. 13 illustrates the conducting device 100 transmitting the data packets 204a-d and the mixed packets 130 via several “one-to-one” connected isochronous streams. Further, the mixed packets 130 may contain audio data originating from the conducting device 100 and/or one or more of the audio sources 200a-d.

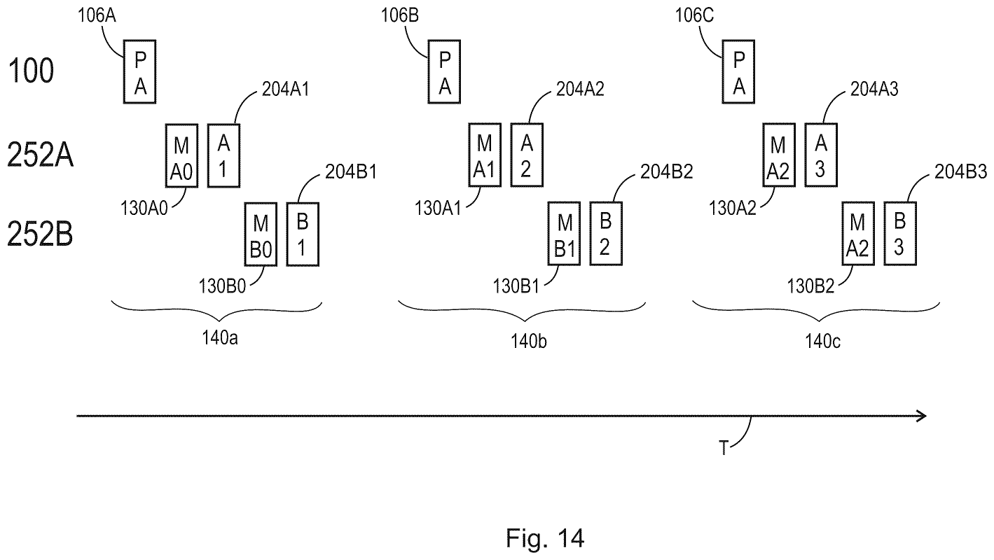

FIG. 14 is a flow diagram illustrating a wireless transmission topology of the system 10 of FIG. 13. As with FIGS. 9, 10, and 12, for the sake of clarity, the flow diagram of FIG. 14 assumes that the only active devices in the system 10 are the conducting device 100, the first audio source 200a, and the second audio source 200b. Accordingly, any transmissions related to the third or fourth audio sources 200c, 200d are omitted. Further, FIG. 14 omits retransmission cycles 142a, 142b. In the first transmission cycle 140a, rather than receiving a poll packet 216, the conducting device 100 transmits a mixed packet 130a0 to the first audio source 200a via the first connected isochronous stream 252a. This mixed packet 130a0 includes a mix or blend of audio data received by the conducting device 100 prior to the first transmission cycle 140a. For example, the mixed packet 130a0 may contain audio data corresponding to a data packet of the second audio source 200b or the conducting device 100. In this example, the mixed packet 130a0 does not include data originating from the first audio source 200a. Therefore, the system 10 avoids unnecessarily transmitting audio data back to the audio source 200 which originally generates the audio data by generating mixed packets 130 customized for each audio device 200 of the system 10. In response to receiving the mixed packet 130a0, the first audio source 200a transmits a first data packet 204a1 via the first connected isochronous stream 252a to the conducting device 100.

Subsequently, the conducting device 100 transmits a mixed packet 130b0 to the second audio source 200b via the second connected isochronous stream 252b. For example, the mixed packet 130b0 may contain audio data corresponding to data packets of the first audio source 200a or the conducting device 100. Accordingly, the mixed packet 130b0 does not include data originating from the second audio source 200b. The second audio source 200b then transmits a first data packet 204b1 via a second connected isochronous stream 252b to the conducting device 100.

This aforementioned process repeats in the second isochronous interval 104b. The conducting device 100 transmits a mixed packet 130a1 to the first audio source 200a via the first connected isochronous stream 252a. This mixed packet 130a1 includes mixed audio data received by the conducting device 100 prior to the second transmission cycle 140b, including the first data packet 204b1 from the second audio source 104b as well as data generated by the conducting device 100. In response to receiving the mixed packet 130a1, the first audio source 200a transmits a second data packet 204a2 via the first connected isochronous stream 252a to the conducting device 100. Similarly, the conducting device 100 transmits a mixed packet 130b1 to the second audio source 200b via the second connected isochronous stream 252b. The mixed packet 130b 1 may contain audio data corresponding to the first data packet 204a1 from the first audio source 200a as well as data from the conducting device 100. In response to receiving the mixed packet 130b1, the second audio source 200b then transmits a second data packet 204b2 via the second connected isochronous stream 252b to the conducting device 100. The aforementioned processes are then repeated in the third isochronous interval 140c.

FIG. 15 illustrates a schematic diagram of a non-limiting example of an audio source 200. As described above, the audio source 200 may be one of a wide variety of devices, such as a set of headphones, a set of earbuds, an audio headset, a set of audio eyeglasses, a hearing aid, or any other type of wearable audio device. The audio source 200 may also be a non-wearable audio device, such as a speaker. Broadly, the audio source 200 includes a memory 225, a microphone 265, a speaker 275, a transceiver 285, and a processor 295. The memory 225 may store a wide variety of data, such as data related to isochronous streams 202 transmitted by the audio source 200 of FIG. 12 or another audio source of the system 10. The memory 225 may also store data related to isochronous streams 102 transmitted by a conducting device 100. The memory 225 may also store periodic advertisements 106 transmitted by the conducting device 100. The processor 295 uses the group timing information 108 of the periodic advertisements 106 to time-align and synchronize the various isochronous streams 102, 202 transmitted or received by the audio source 200. The microphone 265 is used to capture voice audio (or other environmental audio proximate to the audio source 200, when applicable) to be transmitted via the isochronous streams 202. The speaker 275 is used to render, according to the accompanying destination data 114, 214, audio data 112, 212 received from the various isochronous streams 102, 202. The transceiver 285 is used to facilitate transmitting and receiving data packets 104, 204 via the various isochronous streams 102, 202.

FIG. 16 illustrates a schematic diagram of a non-limiting example of a conducting device 100. As described above, the conducting device 100 may be one of a wide variety of devices, such as, but non-limited to, an in-vehicle infotainment system, a television, or a speaker. Broadly, the conducting device 100 includes a memory 125, a transceiver 185, and a processor 195. The memory 125 may store a wide variety of data, such as data related to isochronous streams 202, 252 transmitted by an audio source 200 and received by the conducting device 100. The memory 125 may also store data related to isochronous streams 102 transmitted by the conducting device 100. The memory 125 may also store periodic advertisements 106 transmitted by the conducting device 100. The processor 195 uses the group timing information 108 of the periodic advertisements 106 to time-align and synchronize the various isochronous streams 102, 202 transmitted or received by the conducting device 100. Aspects of the periodic advertisement 106 and the group timing information 108 may be generated by the processor 195. The transceiver 185 is used to facilitate transmitting and receiving data packets 104, 204 via the various isochronous streams 102, 202.

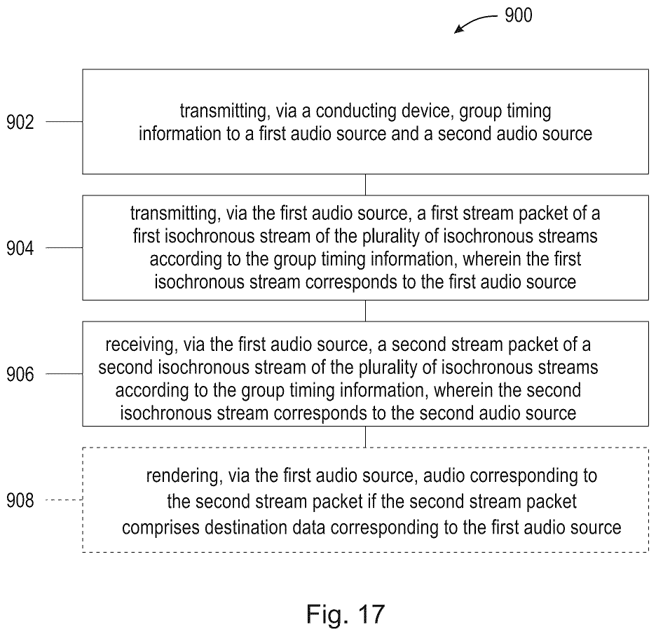

FIG. 17 illustrates the steps of an exemplary method 900 according to the present disclosure. The method 900 includes, for example: (1) transmitting 902, via a conducting device, group timing information to a first audio source and a second audio source; (2) transmitting 904, via the first audio source, a first stream packet of a first isochronous stream of the plurality of isochronous streams according to the group timing information, wherein the first isochronous stream corresponds to the first audio source; and (3) receiving 906, via the first audio source, a second stream packet of a second isochronous stream of the plurality of isochronous streams according to the group timing information, wherein the second isochronous stream corresponds to the second audio source. The method 900 may further include the optional step of rendering 908, via the first audio source, audio corresponding to the second stream packet if the second stream packet comprises destination data corresponding to the first audio source.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A system for synchronizing a plurality of isochronous streams, comprising:
a first audio source of a plurality of audio sources, the first audio source configured to:
transmit a first stream packet of a first isochronous stream of the plurality of isochronous streams according to group timing information, wherein the first stream packet corresponds to the first audio source; and
receive a second stream packet of a second isochronous stream of the plurality of isochronous streams according to the group timing information, wherein the second stream packet corresponds to a second audio source of the plurality of audio sources; and
a conducting device configured to transmit the group timing information to the first audio source and the second audio source, wherein the plurality of isochronous streams are synchronized to form an isochronous group.

2. The system of claim 1, wherein the conducting device provides the group timing information via a periodic advertisement transmitted to the first audio source and the second audio source.

3. The system of claim 1, wherein the second stream packet comprises destination data corresponding to at least one of the plurality of audio sources.

4. The system of claim 3, wherein the first audio source renders audio corresponding to the second stream packet if the destination data corresponds to the first audio source.

5. The system of claim 3, wherein the first audio source disables reception of the second stream packet if the destination data does not correspond to the first audio source.

6. The system of claim 1, wherein the first stream packet corresponds to audio captured by the first audio source and/or the second stream packet corresponds to audio captured by the second audio source.

7. The system of claim 1, wherein the first audio source transmits the first stream packet to the second audio source via the first isochronous stream according to the group timing information, and wherein the first isochronous stream is a Broadcast Isochronous Stream.

8. The system of claim 7, wherein the second audio source transmits the second stream packet to the first audio source via the second isochronous stream according to the group timing information, and wherein the second isochronous stream is a Broadcast Isochronous Stream.

9. The system of claim 8, wherein the first stream packet is transmitted at a first time, and the second stream packet is transmitted at second time subsequent to the first time.

10. The system of claim 9, wherein the conducting device transmits a third stream packet of a third isochronous stream to the first audio source and the second audio source at a third time prior to the first time.

11. The system of claim 1, wherein the first audio source transmits the first stream packet to the conducting device via the first isochronous stream according to the group timing information, and wherein the first isochronous stream is a Connected Isochronous Stream.

12. The system of claim 11, wherein the second audio source transmits the second stream packet to the conducting device via a third isochronous stream of the plurality of isochronous streams according to the group timing information, and wherein the third isochronous stream is a Connected Isochronous Stream.

13. The system of claim 12, wherein the conducting device transmits the first stream packet to the second audio source via a fourth isochronous stream of the plurality of isochronous streams, according to the group timing information, and wherein the fourth isochronous stream is a Broadcast Isochronous Stream.

14. The system of claim 13, wherein the conducting device transmits the second stream packet to the first audio source via the second isochronous stream according to the group timing information, and wherein the second isochronous stream is a Broadcast Isochronous Stream.

15. The system of claim 12, wherein the conducting device transmits the first stream packet to the second audio source via a fourth isochronous stream of the plurality of isochronous streams, according to the group timing information, and wherein the fourth isochronous stream is a Connected Isochronous Stream.

16. The system of claim 15, wherein the conducting device transmits the second stream packet to the first audio source via the second isochronous stream according to the group timing information, and wherein the second isochronous stream is a Connected Isochronous Stream.

17. The system of claim 1, wherein the conducting device is an in-vehicle infotainment system, a television, or a speaker.

18. The system of claim 1, wherein the first audio source and/or the second audio source is a set of headphones, an earbud, an audio headset, a set of audio eyeglasses, or a speaker.

19. A method for synchronizing a plurality of isochronous streams, comprising:
transmitting, via a conducting device, group timing information to a first audio source and a second audio source;
transmitting, via the first audio source, a first stream packet of a first isochronous stream of the plurality of isochronous streams according to the group timing information, wherein the first isochronous stream corresponds to the first audio source; and
receiving, via the first audio source, a second stream packet of a second isochronous stream of the plurality of isochronous streams according to the group timing information, wherein the second isochronous stream corresponds to the second audio source,
wherein the plurality of isochronous streams are synchronized to form an isochronous group.

20. The method of claim 19, further comprising rendering, via the first audio source, audio corresponding to the second stream packet if the second stream packet comprises destination data corresponding to the first audio source.
